(19) United States
(12) Patent Application Publication
(10) Pub. No.: US 2026/0133798 A1
(43) Pub. Date: May 14, 2026

(54) METHOD AND APPARATUS FOR ADDRESSING REGISTERS WITHIN A PROCESSOR BASED ON INDIRECT REGISTERS

(71) Applicant: International Business Machines Corporation, Armonk, NY (US)

(72) Inventors: Robert A. Philhower, Valley Cottage, NY (US); Robert K. Montoye, YORKTOWN HEIGHTS, NY (US); John-David Wellman, HOPEWELL JUNCTION, NY (US)

(73) Assignee: International Business Machines Corporation, Armonk, NY (US)

(21) Appl. No.: 18/944,116

(22) Filed: Nov. 12, 2024

(51) Int. Cl. G06F 9/30

(52) U.S. Cl. CPC G06F 9/30036; G06F 9/30138; G06F 9/3455

(57) ABSTRACT

A vector table for addressing registers within a processor is disclosed. The vector table includes multiple vector table entries to allow a processor to access a set of registers indirectly. One of the vector table entries includes a register entry number field containing an entry number to indicate a first entry to the set of registers; a vector length field containing a number to indicate whether the one vector table entry points to a single entry of the set of registers or multiple entries of the set of registers concurrently; and a vector stride pattern field containing a stride number to indicate a relative distance between the first entry of the set of registers and another entries of the set of registers when the one vector table entry points to multiple entries of the set of registers.

### TECHNICAL FIELD

The present invention relates to the management of registers within a processor in general, and in particular, to a method and apparatus for addressing registers within a processor.

### BACKGROUND

Modern processors tend to employ a relatively large number of registers for storing data. This is because for data manipulations, using registers is generally more preferable than system memories in many aspects. For example, registers can typically be designated with fewer bits within an instruction than memory addresses of a system memory. In addition, registers have faster access time than most system memories.

Although the performance of a processor can generally be improved by increasing the number of registers within the processor, a large number of architected registers can present new problems as well. One of these problems is register addressability. There is a limited number of bits within an instruction that can be allocated solely for the purpose of addressing registers. Thus, the maximum number of registers within a processor that can be directly addressed is effectively constrained.

Consequently, it would be desirable to provide an improved method and apparatus for increasing the ability of a processor to address a large number of registers within the processor.

### SUMMARY OF THE INVENTION

In accordance with one embodiment of the present invention, a processor includes a set of registers and a vector table having multiple vector table entries to allow the processor to access the set of registers indirectly. One of the vector table entries includes a register entry number field containing an entry number to indicate a first entry to the set of registers; a vector length field containing a number to indicate whether the one vector table entry points to a single entry of the set of registers or multiple entries of the set of registers concurrently; and a vector stride pattern field containing a stride number to indicate a relative distance between the first entry of the set of registers and another entries of the set of registers when the one vector table entry points to multiple entries of the set of registers.

### BRIEF DESCRIPTION OF THE DRAWINGS

FIG. 1 FIG. 1 is a block diagram of a processor in which one embodiment of the present invention can be incorporated;

FIG. 2A is a block diagram illustrating direct addressing of registers;

FIG. 2B is a block diagram illustrating indirect addressing of registers;

FIGS. 3A-3B are block diagrams illustrating vector addressing of registers, according to one embodiment of the present invention;

FIG. 4 is an example of an ADD instruction using vector addressing for a single entry, according to one embodiment of the present invention; and

FIG. 5 is an example of an ADD instruction using vector addressing for multiple entries, according to one embodiment of the present invention.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

The present invention may be implemented in reduced instruction set computing (RISC) processors or complex instruction set computing (CISC) processors.

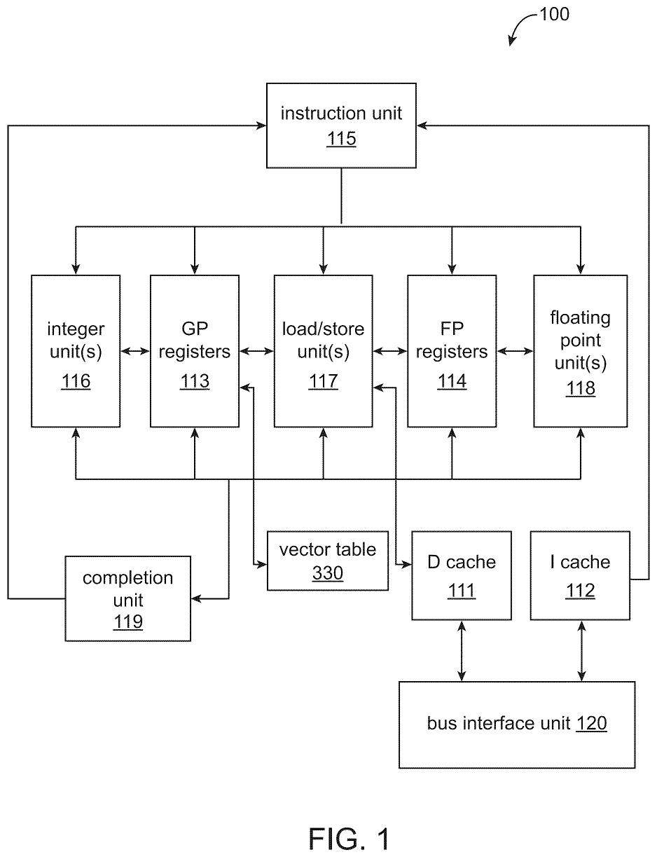

Referring now to the drawings, and in particular to FIG. 1, there is illustrated a block diagram of a processor in which one embodiment of the present invention can be incorporated. As shown, a processor 100 includes a data cache 111 and an instruction cache 112, both of which are connected to a bus interface unit 120. Instructions retrieved from a system memory (not shown) via bus interface unit 120 can be stored in instruction cache 112. Data retrieved via bus interface unit 120 are stored in data cache 111. Instructions are fetched as needed from instruction cache 112 by an instruction unit 115 that includes an instruction fetcher, a branch prediction module, an instruction queue and a dispatch unit.

Instruction unit 115 dispatches instructions as appropriate to execution units such as an integer unit 116, a load/store unit 117 and/or a floating-point unit 118. Integer unit 116 performs add, subtract, multiply, divide, shift or rotate operations on integers, retrieving operands from and storing results to general purpose registers 113. Floating-point unit 118 performs single-precision and/or double-precision multiply/add operations, retrieving operands from and storing results to floating-point registers 114. Load/store unit 117 loads instruction operands from data cache 111 into general purpose registers 113 or floating-point registers 114, as needed, and stores instruction results when available from general purpose registers 113 or floating-point registers 114 into data cache 111.

A completion unit 119, which includes multiple reorder buffers, operates in conjunction with instruction unit 115 to support out of order instruction processing. Completion unit 119 also operates in connection with rename buffers within general purpose registers 113 and floating-point registers 114 to avoid any conflict in a specific register for instruction results.

There are two ways for a processor, such as processor 100, to address its registers, such as general purpose registers 113 and floating-point registers 114, namely, direct addressing and indirect addressing.

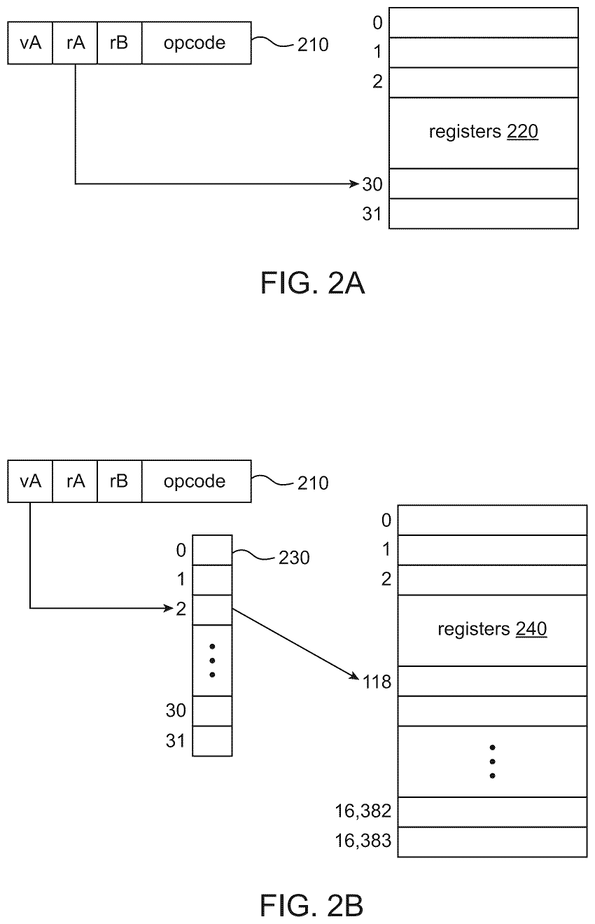

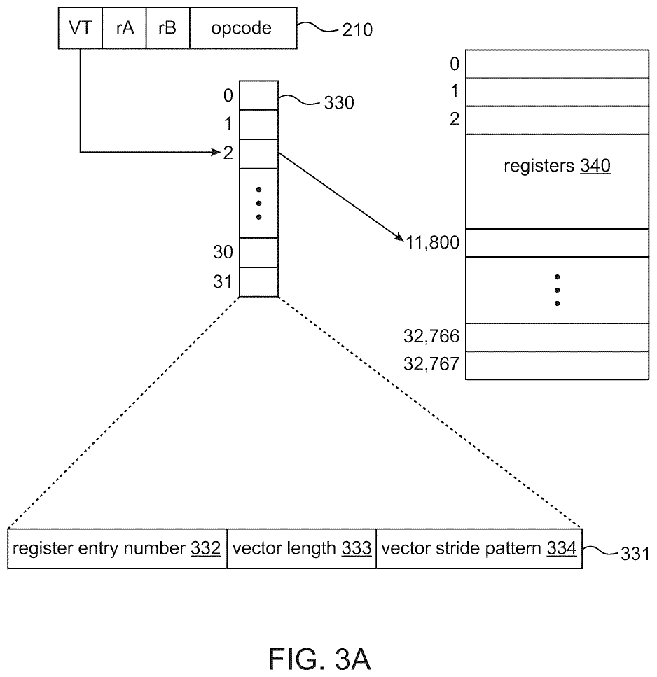

With reference now to FIG. 2A, there is depicted a block diagram illustrating direct addressing of registers. As shown, an instruction 210 includes two direct register fields rA and rB, each containing an entry number for directly indexing a set of registers 220. In this example, the rA field of instruction 210 contains a number 30 for directly indexing entry 30 of registers 220.

The total number of addressable entries within registers 220 may equal two to the power of the total number of bits in each of the rA and B fields allocated for addressing registers 220. For example, if the total number of bits in the rA field is three, then the number of addressable entries within registers 220 is eight; if the total number of bits in rA field is four, then the number of addressable entries within registers 220 is sixteen. For the embodiment shown in FIG. 2A, the total number of bits in each of rA field and rB field is five, and the maximum number of addressable entries within registers 220 is thirty-two. Thus, one limitation of direct addressing is that the total number of addressable registers is relatively small because of the small number of bits allocated in an instruction for addressing registers. When there is a relatively small number of addressable registers within a processor, data have to be transferred to and from a system memory repeatedly, which may lead to a problem known as “register pressure” that can reduce the performance of the processor.

The register pressure problem can be mitigated by employing more registers. The register addressability problem can be overcome by using indirect addressing of registers.

With reference now to FIG. 2B, there is depicted a block diagram illustrating indirect addressing of registers. As shown, instruction 210 includes an indirect register field vA containing an entry number for indexing indirect registers 230, the entries of which point to registers 240. The total number of addressable entries within indirect registers 230 may equal two to the power of the total number of bits in the vA field allocated for addressing indirect registers 230. In the embodiment shown in FIG. 2B, the total number of bits in the vA field is five, and the maximum number of addressable entries within indirect registers 230 is 32.

Registers 240 also include multiple addressable entries. Any entry within registers 240 can be indexed by the bits within an entry of indirect registers 230, which is selected by the bits within the vA field of instruction 210. For example, entry 118 within registers 240 is indexed by the bits contained within entry 2 of indirect registers 230, which is selected by the bits contained within the vA field of instruction 210.

The number of bits in each indirect register entry is large enough to address all the addressable entries within registers 240. The total number of addressable registers within registers 240 may be equal to at least two to the power of the total number of bits within an entry of indirect registers 230. For example, if the number of bits within each entry of indirect register 230 is six, then the total number of addressable registers within registers 231 is 64. In the embodiment shown in FIG. 2B, the total number of bits within each entry of indirect registers 230 is fourteen, and the total number of addressable entries within registers 240 is 16,384.

One advantage of indirect addressing over direct addressing is that indirect addressing allows for a relatively large register file, which can reduce the above-mentioned register pressure problem. For example, the increase in the number of registers from 32 (in registers 220) to 16,384 (in registers 240) reduces register pressure in a register file because more data can be stored in registers without the need of transferring data to and from a system memory repeatedly.

Although the number of addressable register entries can be much larger by using indirect addressing (instead of direct addressing), the number of entries of indirect registers 230 is still limited by the bit length of the allocated register fields within an instruction such as instruction 210. Thus, indirect registers 230 may experience register pressure because pointers still need to be moved in and out of indirect registers 230, potentially for each register access. Thus, an improved register addressing scheme is desired.

In accordance with one embodiment of the present invention, indirect registers 230 in FIG. 2B is replaced by a vector table. For the present embodiment, a vector table 330 can be associated with general purpose registers 113 and/or floating-point registers 114 within processor 100 of FIG. 1.

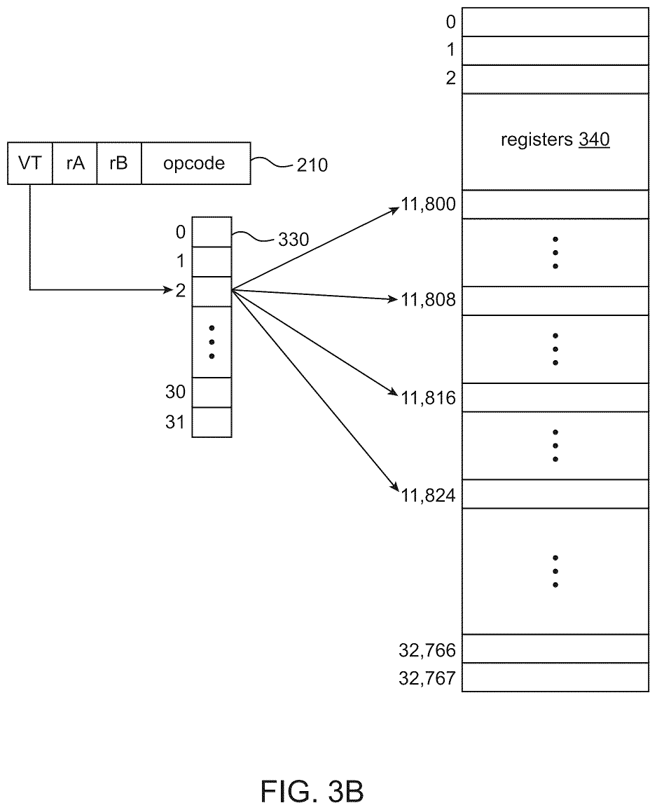

Referring now to FIGS. 3A-3B, there are illustrated vector addressing of registers, according to one embodiment of the present invention. As shown in FIG. 3A, instruction 210 includes a vector table field VT containing an entry number for indexing a vector table 330. The total number of addressable entries within vector table 330 may equal two to the power of the total number of bits in the VT field allocated for addressing vector table 330. For the present embodiment, the total number of bits in the VT field is five, and the maximum number of addressable entries within vector table 330 is 32.

Registers 340 include multiple addressable entries. For the present embodiment, registers 340 have 32,678 entries. Any entry within registers 340 can be indexed by the bits within an entry of vector table 330, which is selected by the bits within the VT field of instruction 210.

As shown in FIG. 3A, a vector table entry 331 of vector table 330 includes three fields, namely, a register entry number field 332, a vector length field 333, and a vector stride pattern field 334. By using register entry number field 332, vector length field 333, and vector stride pattern field 334 together, vector table entry 331 is able to point to a single entry of registers 340 (as shown in FIG. 3A) or a set of multiple entries of registers 340 concurrently (as shown in FIG. 3B). For multiple entries, the starting point of a set is specified by register entry number field 332, and the cardinality of the set is specified by vector length field 333.

Specifically, register entry number field 332 contains an entry number for indexing registers 340. For the present embodiment, the total number of bits in register entry number field 332 is 15, which allows all 32,768 entries of registers 340 to be indexed.

Vector length field 333 indicates whether vector table entry 331 points to a single entry or multiple entries of registers 340. For the present embodiment, there are four bits in vector length field 333, and the relationship between the four bits and their corresponding vector length indications are listed in Table I as follows:

TABLE I

| bits | vector length |
|---|---|
| 0000 | single entry |
| 0001 | 2 |
| 0010 | 4 |
| 0011 | 8 |
| 0100 | 16 |
| 0101 | 32 |
| 0110 | 64 |
| 0111 | 128 |
| 1000 | 256 |
| 1001 | 512 |
| 1010 | 1,024 |
| 1011 | 2,048 |
| 1100 | 4,096 |
| 1101-1111 | reserved |

When vector length field 333 contains 0000, it means that vector register entry 331 points to a single entry in registers 340, as shown in FIG. 3A. Otherwise, vector register entry 331 points multiple entries of registers 340, as shown in FIG. 3B. The bit pattern in vector length field 333 indicates the number of multiple entries within registers 340 to be indexed, as listed in Table I. For example, when vector length field 333 contains 0001, it means that vector register entry 331 points to two entries within registers 340 concurrently. When vector length field 333 contains 0011, it means that vector register entry 331 points to eight entries within registers 340 concurrently. When vector length field 333 contains 0110, it means that vector register entry 331 points to sixty-four entries within registers 340 concurrently.

The ability to use one entry (i.e., vector table entry 331) of vector table 330 for indexing multiple entries of registers 340 helps to reduce register pressure on vector table 330, even though the size of vector table 330 is limited by the number of bits within the VT field of instruction 210.

Vector stride pattern field 334 indicates a stride pattern or distance from the entry number contained in register entry number field 332. For the present embodiment, there are four bits in vector stride pattern field 334, and the relationship between the four bits and their corresponding stride pattern indication are listed in Table II as follows:

TABLE II

| bits | stride pattern |
|---|---|
| 0000 | 1 |
| 0001 | 2 |
| 0010 | 4 |
| 0011 | 8 |
| 0100 | 16 |
| 0101 | 32 |
| 0110 | 64 |
| 0111 | 128 |
| 1000-1111 | reserved |

In essence, a stride pattern indicates a stride number (distance) that needs to be added to an entry number contained in register entry number field 332 in order to index the next entry in registers 340. In other words, each of the multiple entry numbers to registers 340 is incremented by the stride number. For example, if register entry number field 332 contains 11,800 (in decimal) and vector stride pattern field 334 contains 0000 (in binary), then the second pointer will point to entry 11,800+1=11,801 entry of register 340, and the third pointer will point to entry 11,801+1=11,802 entry of register 340, for the total number of entries specified in vector length field 333. If register entry number field 332 contains 11,800 (in decimal) and vector stride pattern field 334 contains 0001 (in binary), then the second pointer will point to entry 11,800+2=11,802 entry of register 340, and the third pointer will point to entry 11,802+4=11,804 entry of register 340, for the total number of entries specified in vector length field 333.

As another example with all three fields (i.e., register entry number field 332, vector length field 333, and vector stride pattern field 334) together, if register entry number field 332 contains 11,800 (in decimal), vector length field 333 contains 0010 (in binary) and vector stride pattern field 334 contains 0011 (in binary), then vector table entry 331 will point to four entries—11,800; 11,808; 11,816; and 11,824—of registers 340 concurrently, as shown in FIG. 3B.

Vector table 330 can be updated through an instruction, such as MIMVT (Move Into Mapping Vector Table), that moves data into vector table 330. The MIMVT instruction operates by moving an “integer value” into vector table 330, which comes from a separate set of integer registers (not shown). After vector table 330 has been read for a given instruction and while the vectored set of independent instructions is executing, subsequent MIMVT instructions may execute and update vector table 330 to set up for further vectored instructions. This feature serves to further reduce the register pressure on vector table 330.

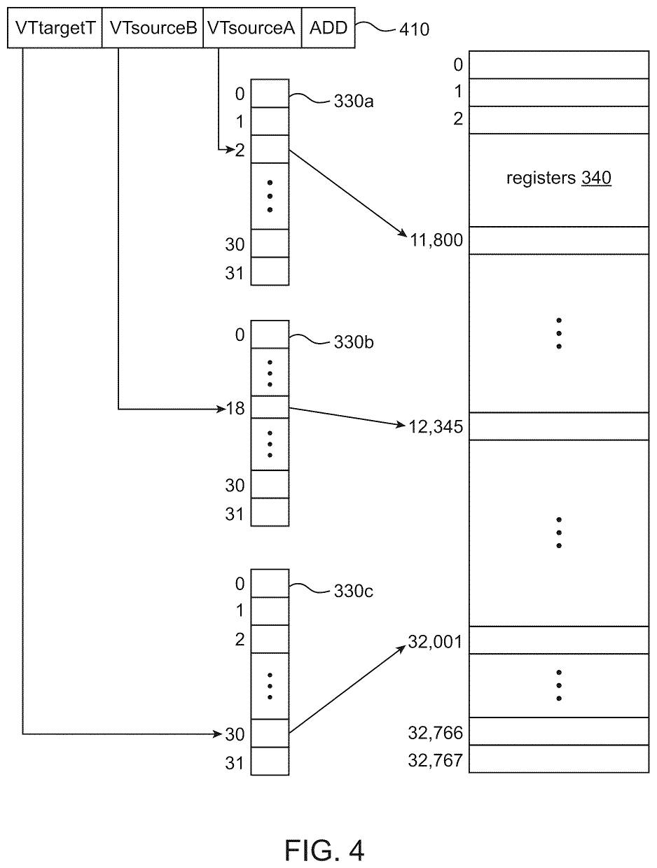

With reference now to FIG. 4, there is depicted an example of an ADD instruction 410 using vector addressing for a single entry, according to one embodiment of the present invention. The function of ADD instruction 410 is to add the values in source A and source B and places the sum in target T. Source A, source B and target T are entries of registers 340. As shown, ADD instruction 410 includes a VT field for source A, a VT field for source B, and a VT field for target T. The VT field for source A points to entry 2 of vector table 330a, which points to entry 11,800 of registers 340. The VT field for source B points to entry 18 of vector table 330b, which points to entry 12,345 of registers 340. The VT field for target T points to entry 30 of vector table 330c, which points to entry 32,001 of registers 340. Since this is a single-entry addressing, the bits in the vector length fields in entry 2 of vector table 330a, entry 18 of vector table 330b, and entry 30 of vector table 330c are all 0000.

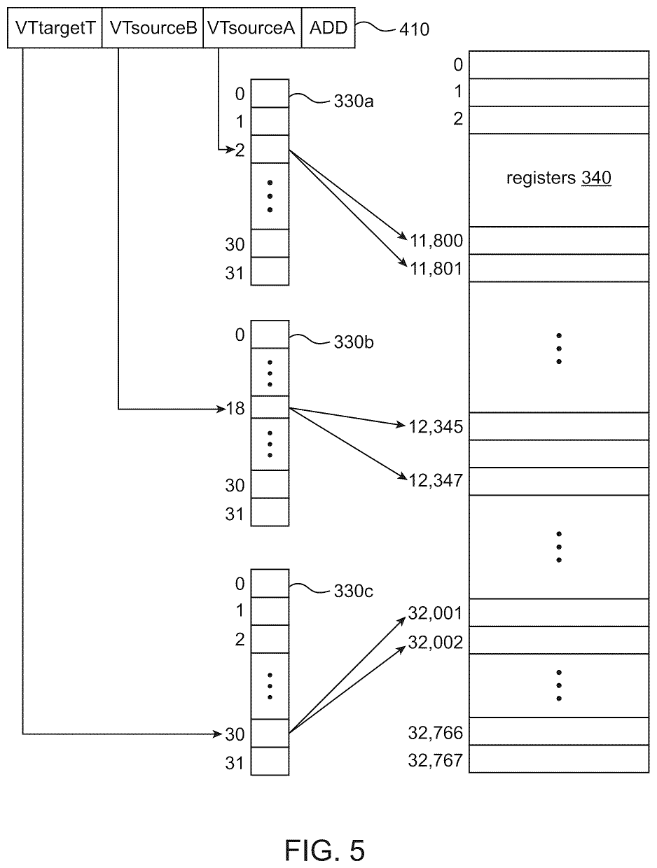

Referring now to FIG. 5, there is depicted an example of ADD instruction 410 using vector addressing for multiple entries, according to one embodiment of the present invention. As above, the function of ADD instruction 410 is to add the values in source A and source B and places the sum in target T. In this example, three separate vector tables 330a-330c are utilized to index register 340, and their entries are as follows:

| | register entry | vector | vector stride |
|---|---|---|---|
| | number field | length field | pattern field |
| vector table 330a entry 2 | 11,800_{dec} | 0001_{bin} | 0000_{bin} |
| vector table 330b entry 18 | 12,345_{dec} | 0001_{bin} | 0001_{bin} |
| vector table 330c entry 30 | 32,001_{dec} | 0001_{bin} | 0000_{bin} |

In this example, each entry in vector tables 330a-330c points to two entries in register 340 concurrently, so the ADD instruction needs to be performed twice, one per entry in register 340. The first ADD instruction combines entry 11,800 (source A) and entry 12,345 (source B) of register 340, and stores the result into entry 32,001 (target T) of register 340. The second ADD instruction combines entry 11,801 (source A) and entry 12,347 (source B) of register 340, and stores the result into entry 32,002 (target T) of register 340. Although the ADD instruction needs to be performed twice, the advantage is that the pointers to vector tables 330a-330c do not need to be changed. This serves to reduce the register pressure on vector tables 330a-330c.

If the values stored in vector length field 333 in vector tables 330a-330c are not identical to each other, then the highest value dominates. Continuing with this example, if the value stored in vector length field 333 of entry 30 of vector table 330c is 0010 (in binary), instead of 0001 (in binary) like the other two entries, as follows:

| | register entry | vector | vector stride |
|---|---|---|---|
| | number field | length field | pattern field |
| vector table 330a entry 2 | 11,800_{dec} | 0001_{bin} | 0000_{bin} |
| vector table 330b entry 18 | 12,345_{dec} | 0001_{bin} | 0001_{bin} |
| vector table 330c entry 30 | 32,001_{dec} | 0010_{bin} | 0000_{bin} |

then 0010 (in binary) dominates, and the ADD instruction will repeat four times, according to Table I

As has been described, the present invention provides an improved method and apparatus for addressing registers within a processor.

While the invention has been particularly shown and described with reference to a preferred embodiment, it will be understood by those skilled in the art that various changes in form and detail may be made therein without departing from the spirit and scope of the invention.

1. An apparatus comprising:
a set of registers; and
a first vector table having a plurality of vector table entries, each vector table entry being
selectable by a vector table index field within an instruction, wherein a processor is configured to access said registers indirectly, and wherein one of said vector table entries includes:
a register entry number field containing a register entry number to indicate a first entry of said registers;
a vector length field containing a vector length number to indicate whether said one vector table entry points to a single entry of said registers or multiple entries of said registers concurrently; and
a vector stride pattern field containing a stride number to indicate a relative distance between said first entry of said registers and at least one another entry of said registers when said one vector table entry points to multiple entries of said registers concurrently.

2. The apparatus of claim 1, wherein a number of said vector table entries in said vector table is less than a number of register entries in said registers.

3. The apparatus of claim 1, wherein said one vector table entry is indexed by a vector table field in an instruction.

4. The apparatus of claim 1, wherein said vector table is updated through an instruction that moves data from a storage location into said vector table.

5. The apparatus of claim 4, wherein said storage location is an integer register.

6. The apparatus of claim 1, wherein said vector length number in said vector length field specifies a total number of entries in said registers that is being indexed concurrently by said one vector table entry.

7. The apparatus of claim 1, wherein an instruction needs to be executed as many times as said vector length number in said vector length field, when said one vector table entry points to multiple entries of said registers concurrently.

8. The apparatus of claim 1, wherein said stride number in said vector stride pattern field specifies a distance between a first entry among the at least one another register of said registers and a second entry among the at least one another register of said registers, and the distance between said second entry of said registers and a third entry among the at least one another register of said registers, when said one vector table entry points to multiple entries of said registers concurrently.

9. The apparatus of claim 1, wherein said processor further includes a second vector table having a plurality of second vector table entries, each of the second vector table entries being selectable by a second vector table index field within the instruction, wherein said processor is configured to access said registers indirectly, and wherein one of said second vector table entries includes:
a register entry number field containing a register entry number to indicate a first entry of said registers;
a vector length field containing a vector length number to indicate whether said one second vector table entry points to a single entry of said registers or multiple entries of said registers concurrently; and
a vector stride pattern field containing a stride number to indicate a relative distance between a first entry of said registers and at least one another entry of said registers when said one second vector table entry points to multiple entries of said registers concurrently.

10. The apparatus of claim 9, wherein when values stored in vector length fields in said first and second vector tables are not identical to each other, a highest value dominates.

11. A method for addressing registers within a processor, said method comprising:
providing a set of registers; and
associating a first vector table with said set of registers, each vector table entry being selectable by a vector table index field within an instruction, wherein said processor to access said registers indirectly, wherein said vector table includes a plurality of vector table entries, wherein one of said vector table entries includes;
a register entry number field containing a register entry number to indicate a first entry of said registers;
a vector length field containing a vector length number to indicate whether said one vector table entry points to a single entry of said registers or multiple entries of said registers concurrently; and
determining one vector table entry points to multiple entries of said registers concurrently
a vector stride pattern field containing a stride number to indicate a relative distance between said first entry of said registers and at least one another entry of said registers in response to said one vector table entry pointing to multiple entries of said registers concurrently.

12. The method of claim 11, wherein a number of said vector table entries in said vector table is less than a number of register entries in said registers.

13. The method of claim 11, wherein said one vector table entry is indexed by a vector table field in an instruction.

14. The method of claim 11, further comprising updating said vector table via an instruction that moves data from a storage location into said vector table.

15. The method of claim 14, wherein said storage location is an integer register.

16. The method of claim 11, wherein said vector length number in said vector length field specifies a total number of entries in said registers that is being indexed concurrently by said one vector table entry.

17. The method of claim 11, wherein an instruction needs to be executed as many times as said vector length number in said vector length field, when said one vector table entry points to multiple entries of said registers concurrently.

18. The method of claim 11, wherein said stride number in said vector stride pattern field specifies a distance between a first entry among the at least one another register of said registers and a second entry among the at least one another register of said registers, and a distance between said second entry of said registers and a third entry among the at least one another register of said registers, when said one vector table entry points to multiple entries of said registers concurrently.

19. The method of claim 11, wherein said method further associating a second vector table with said set of registers such that said processor to access said registers indirectly, wherein said second vector table includes a plurality of second vector table entries, each of the second vector table entries being selectable by a second vector table index field within the instruction, wherein said processor is configured to access said registers indirectly, and wherein one of said second vector table entries includes:
a register entry number field containing a register entry number to indicate a first entry of said registers;
a vector length field containing a vector length number to indicate whether said one second vector table entry points to a single entry of said registers or multiple entries of said registers concurrently; and
a vector stride pattern field containing a stride number to indicate a relative distance between a first entry of said registers and at least one another entry of said registers when said one second vector table entry points to multiple entries of said registers concurrently.

20. The method of claim 19, wherein when values stored in vector length fields in said first and second vector tables are not identical to each other, a highest value dominates.
